(19) United States
(12) Patent Application Publication
(10) Pub. No.: US 2024/0228375 A1
(43) Pub. Date: Jul. 11, 2024

(54) PERLITE-BASED CEMENTITIOUS MATERIALS, CONCRETE, AND RELATED TECHNIQUES

(71) Applicant: VHSC, LTD., Tortola (VG)

(72) Inventor: Clinton W. Pike, Sr., Montgomery, TX (US)

(21) Appl. No.: 18/577,738

(22) PCT Filed: Feb. 15, 2022
(86) PCT No.: PCT/US2022/016382

§ 371 Date: Jan. 9, 2024

Related U.S. Application Data
(60) Provisional application No. 63/220,392, filed on Jul. 9, 2021.
(60) Provisional application No. 63/244,447, filed on Sep. 15, 2021.
(60) Provisional application No. 63/308,566, filed on Feb. 10, 2022.

(51) Int. Cl. C04B 14/18; C04B 7/02; C04B 14/06; C04B 24/26; C04B 28/04; C04B 28/14; C04B 28/28; C04B 40/00

(52) U.S. Cl. CPC C04B 14/185; C04B 7/02; C04B 14/06; C04B 24/2623; C04B 28/04; C04B 28/14; C04B 28/28; C04B 40/0046

(57) ABSTRACT

Treated perlite-based cementitious materials, concrete, and related techniques are disclosed. In accordance with some embodiments, a treated perlite-based cementitious material may be produced by intergrinding raw perlite ore, polyvinyl alcohol (PVA) powder, a polycarboxy late material, and (optionally) at least one of calcium sulfate (CaSO₄) and calcium sulfite (CaSO₃). In accordance with some embodiments, expanded perlite wastes and/or expanded perlite also may be included in the cementitious material. In accordance with some embodiments, raw perlite ore, expanded perlite wastes, and expanded perlite may be combined in providing a cementitious material. In at least some cases, the cementitious material may be provided as an all-in-one powder blend. In accordance with some embodiments, concrete may be produced by mixing the cementitious material with ordinary Portland cement (OPC), sand, rock, and water.

### CROSS-REFERENCE TO RELATED APPLICATIONS

This patent application claims the benefit of: (1) U.S. Provisional Patent Application No. 63/220,392, filed on Jul. 9, 2021; (2) U.S. Provisional Patent Application No. 63/244,447, filed on Sep. 15, 2021; and (3) U.S. Provisional Patent Application No. 63/308,566, filed on Feb. 10, 2022. Each of these patent applications is herein incorporated by reference in its entirety.

### FIELD OF THE DISCLOSURE

The present disclosure relates to cementitious materials and, more particularly, to perlite-based cementitious materials, concrete, and techniques.

### BACKGROUND

Perlite is a naturally occurring amorphous (non-crystalline) volcanic glass, the composition of which typically includes about 70-75% silicon dioxide, about 12-15% aluminum oxide, about 3-5% potassium oxide, about 3-4% sodium oxide, and traces of iron oxide, magnesium oxide, and calcium oxide. Over time, the raw perlite ore matrix absorbs water. Because of its high water content, perlite expands greatly when subjected to sufficient heating. Typically, the perlite “pops” when heated above about 1,300° F. The resultant expanded perlite is notably lightweight and absorptive.

### SUMMARY

The subject matter of this application may involve, in some cases, interrelated products, alternative solutions to a particular problem, and/or a plurality of different uses of a single system or article.

One example embodiment provides a method. The method includes producing a treated perlite-based cementitious mixture including: perlite; polyvinyl alcohol (PVA) powder; and a polycarboxylate material. In some cases, the perlite is raw perlite ore.

In some cases, producing the treated perlite-based cementitious mixture involves intergrinding the raw perlite ore, the PVA powder, and the polycarboxylate material. In some such instances, the intergrinding is performed until a D90 particle size distribution of about 38 μm is achieved for the treated perlite-based cementitious mixture. In some other such instances, the intergrinding is performed until a D90 particle size distribution of about 28 μm is achieved for the treated perlite-based cementitious mixture.

In some cases, the treated perlite-based cementitious mixture further includes at least one of calcium sulfate (CaSO₄) and calcium sulfite (CaSO₃). In some such instances, producing the treated perlite-based cementitious mixture involves intergrinding the raw perlite ore, the PVA powder, the polycarboxylate material, and the at least one of calcium sulfate and calcium sulfite.

In some cases, the treated perlite-based cementitious mixture further includes at least one of expanded perlite waste and expanded perlite. In some such instances, producing the treated perlite-based cementitious mixture involves intergrinding the raw perlite ore, the PVA powder, the polycarboxylate material, and the at least one of expanded perlite waste and expanded perlite.

In some cases, the treated perlite-based cementitious mixture further includes expanded perlite waste and expanded perlite. In some such instances, producing the treated perlite-based cementitious mixture involves intergrinding the raw perlite ore, the PVA powder, the polycarboxylate material, the expanded perlite waste, and the expanded perlite.

Another example embodiment provides a method. The method includes producing a concrete including: the treated perlite-based cementitious mixture produced as described above; ordinary Portland cement (OPC); water; and at least one of rock and sand. In some cases, the treated perlite-based cementitious mixture and the OPC are provided in a 50-50 blend. Another example embodiment provides a concrete product including concrete produced as described above.

Another example embodiment provides a composition of matter. The composition of matter includes: perlite; polyvinyl alcohol (PVA) powder; and a polycarboxylate material. In some cases, the perlite is raw perlite ore. In some cases, the composition of matter has a D90 particle size distribution of about 38 μm. In some cases, the composition of matter has a D90 particle size distribution of about 28 μm. In some cases, the composition of matter further includes at least one of calcium sulfate (CaSO₄) and calcium sulfite (CaSO₃). In some of the aforementioned cases, the composition of matter further includes at least one of expanded perlite waste and expanded perlite. In some of the aforementioned cases, the composition of matter further includes expanded perlite waste and expanded perlite. In some of the aforementioned cases, the composition of matter further includes ordinary Portland cement (OPC).

The features and advantages described herein are not all-inclusive and, in particular, many additional features and advantages will be apparent to one of ordinary skill in the art in view of the drawings, specification, and claims. Moreover, it should be noted that the language used in the specification has been selected principally for readability and instructional purposes and not to limit the scope of the inventive subject matter.

### BRIEF DESCRIPTION OF THE DRAWINGS

FIG. 1 illustrates a method of making a treated perlite-based cementitious material in accordance with an embodiment of the present disclosure.

FIG. 2 illustrates a method of making concrete in accordance with an embodiment of the present disclosure.

These and other features of the present embodiments will be understood better by reading the following detailed description, taken together with the figures herein described. In the drawings, each identical or nearly identical component that is illustrated in various figures may be represented by a like numeral. For purposes of clarity, not every component may be labeled in every drawing. Furthermore, as will be appreciated in light of this disclosure, the accompanying drawings are not intended to be drawn to scale or to limit the described embodiments to the specific configurations shown.

### DETAILED DESCRIPTION

Treated perlite-based cementitious materials, concrete, and related techniques are disclosed. In accordance with some embodiments, a treated perlite-based cementitious material may be produced by intergrinding raw perlite ore, polyvinyl alcohol (PVA) powder, a polycarboxylate material, and (optionally) at least one of calcium sulfate (CaSO₄) and calcium sulfite (CaSO₃). In accordance with some embodiments, expanded perlite wastes and/or expanded perlite also may be included in the cementitious material. In accordance with some embodiments, raw perlite ore, expanded perlite wastes, and expanded perlite may be combined in providing a cementitious material. In at least some cases, the cementitious material may be provided as an all-in-one powder blend. In accordance with some embodiments, concrete may be produced by mixing the cementitious material with ordinary Portland cement (OPC), sand, rock, and water. Numerous configurations and variations will be apparent in light of this disclosure.

### General Overview

Perlite has a high water demand when mixed in water and, as such, has been of limited utility as a replacement for ordinary Portland cement (OPC). This is due, at least in part, to the reactivity of the raw ore's amorphous glass being restricted by the high amount of silicates in the glass and almost no calcium in such. In turn, concretes made with perlite normally exhibit dramatically reduced early compressive strengths as compared to typical OPC-based concretes.

Thus, and in accordance with some embodiments of the present disclosure, treated perlite-based cementitious materials, concrete, and related techniques are disclosed. In accordance with some embodiments, a treated perlite-based cementitious material may be produced by intergrinding raw perlite ore, polyvinyl alcohol (PVA) powder, a polycarboxylate material, and (optionally) at least one of calcium sulfate (CaSO₄) and calcium sulfite (CaSO₃). In accordance with some embodiments, expanded perlite wastes and/or expanded perlite also may be included in the cementitious material. In accordance with some embodiments, raw perlite ore, expanded perlite wastes, and expanded perlite may be combined in providing a cementitious material. In at least some cases, the cementitious material may be provided as an all-in-one powder blend. In accordance with some embodiments, concrete may be produced by mixing the cementitious material with OPC, sand, rock, and water.

As will be appreciated in light of this disclosure, techniques disclosed herein may be utilized in any of a wide range of contexts and applications, including, for example, horticulture, insulation, fills, ceiling tiles, and mortars, among others.

### Treated Perlite-Based Cementitious Material

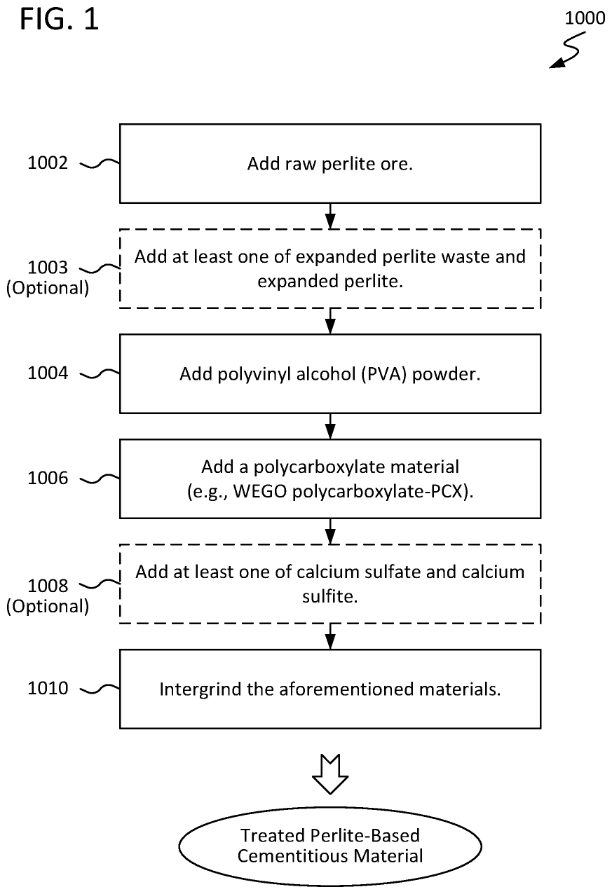

FIG. 1 illustrates a method 1000 of making a treated perlite-based cementitious material in accordance with an embodiment of the present disclosure. As can be seen, method 1000 may include, as in block 1002, adding raw perlite ore. As will be appreciated in light of this disclosure, the raw perlite ore may be sourced as desired for a given target application or end-use. In accordance with some embodiments, the raw perlite ore may be (or otherwise may include) perlite available from Imerys USA, Inc. In accordance with some embodiments, the raw perlite ore may be (or otherwise may include) DICAPERL® perlite available from Dicalite Management Group. The amount of raw perlite ore added may be customized, as desired for a given target application or end-use. In accordance with some embodiments, the raw perlite ore may constitute about 25-50 wt % (e.g., about 25-30 wt %, about 30-35 wt %, about 35-40 wt %, about 40-45 wt %, about 45-50 wt %, or any other sub-range in the range of about 25-50 wt %) of a given mixture produced according to method 1000. Other suitable types and quantities of perlite will be apparent in light of this disclosure.

Method 1000 may include, as in block 1004, adding polyvinyl alcohol (PVA) powder. The amount of PVA powder may be customized, as desired for a given target application or end-use. In accordance with some embodiments, the PVA powder may constitute about 0.1-0.4 wt % (e.g., about 0.1-0.15 wt %, about 0.15-0.2 wt %, about 0.2-0.25 wt %, about 0.25-0.3 wt %, about 0.3-0.35 wt %, about 0.35-0.4 wt %, or any other sub-range in the range of about 0.1-0.4 wt %) of a given mixture produced according to method 1000. Other suitable quantities of PVA powder will be apparent in light of this disclosure.

Method 1000 may include, as in block 1006, adding one or more polycarboxylate materials. In general, the polycarboxylate material may be any of a wide range of polycarboxylate heteropolymer or copolymer (i.e., made from two monomers) materials. In accordance with some embodiments, the polycarboxylate material may be a high-range water reducer. In some instances, a single polycarboxylate material may be utilized, whereas in other instances, a combination of two or more different polycarboxylate materials may be utilized. In at least some cases, it may be desirable for the polycarboxylate material(s) to be in powder form, though this is not required. The amount of polycarboxylate material(s) added may be customized, as desired for a given target application or end-use. In accordance with some embodiments, the polycarboxylate material(s) may constitute about 0.1-0.3 wt % (e.g., about 0.1-0.15 wt %, about 0.15-0.2 wt %, about 0.2-0.25 wt %, about 0.25-0.3 wt %, or any other sub-range in the range of about 0.1-0.3 wt %) of a given mixture produced according to method 1000. Other suitable quantities of polycarboxylate material(s) will be apparent in light of this disclosure.

In accordance with a specific example embodiment, the polycarboxylate material may be a polycarboxylate copolymer, such as Polycarboxylate-PCX CAS NO. 59233-52-2, available from WEGO Chemical and Mineral Corporation of Great Neck, New York, (hereinafter, WEGO Polycarboxylate-PCX), described as a high-range water reducer. WEGO Polycarboxylate-PCX has the following general chemical structure, where (1) M, Y, and X are leaving groups, (2) R¹-R⁴ are aliphatic carbon chains, (3) ethylene oxide (EO) is a hydrophilic component, and (4) propylene oxide (PO) is a hydrophobic component:

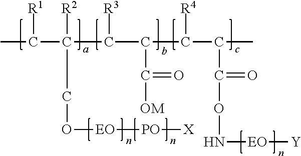

The hydrophilic EO component of WEGO Polycarboxylate-PCX has the following chemical structure:

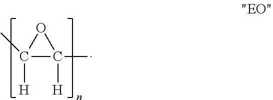

Also, the hydrophobic PO component of WEGO Polycarboxylate-PCX has the following chemical structure:

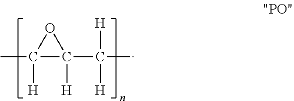

For WEGO Polycarboxylate-PCX, variables a, b, c, and n may be whole integers greater than or equal to 1, and carbon bonds omitted from the illustrated chemical structure of WEGO Polycarboxylate-PCX may be bonded with hydrogen (H). Furthermore, it should be noted that the M, Y, and X leaving groups are proprietary constituents not known outside of WEGO Chemical and Mineral Corp. Nevertheless, even without knowing the M, Y, and X leaving groups, a person having ordinary skill in the art can utilize techniques disclosed herein, including making use of WEGO's commercially available Polycarboxylate-PCX, to produce products, as variously described herein, in accordance with some embodiments of the present disclosure. Also, it should be noted that one or more polycarboxylate materials of chemistry similar to that of WEGO polycarboxylate-PCX may be utilized additionally or alternatively, in accordance with some embodiments.

In accordance with some embodiments, method 1000 optionally may include, as in block 1008, adding at least one of calcium sulfate (CaSO₄) and calcium sulfite (CaSO₃). The amount of calcium sulfate/sulfite may be customized, as desired for a given target application or end-use. In accordance with some embodiments, the calcium sulfate (CaSO₄) may constitute about 0.1-1.5 wt % (e.g., about 0.1-0.5 wt %, about 0.5-1 wt %, about 1-1.5 wt %, or any other sub-range in the range of about 0.1-1.5 wt %) of a given mixture produced according to method 1000. In accordance with some embodiments, the calcium sulfite (CaSO₃) may constitute about 1.5-3 wt % (e.g., about 1.5-2 wt %, about 2-2.5 wt %, about 2.5-3 wt %, or any other sub-range in the range of about 1.5-3 wt %) of a given mixture produced according to method 1000. Other suitable quantities of calcium sulfate (CaSO₄) and calcium sulfite (CaSO₃) will be apparent in light of this disclosure.

Method 1000 may include, as in block 1010, intergrinding the (1) raw perlite ore, (2) PVA powder, (3) polycarboxylate material(s), and (optionally) (4) calcium sulfate and/or calcium sulfite. The noted materials may be interground with one another (e.g., all at once or in one or more intermediate combinations) to provide a treated perlite-based cementitious material, in accordance with some embodiments. In some instances, a given material may have been ground down prior to beginning method 1000, though in other instances, the grinding down of a given material may occur (at least in part) at one or more points during method 1000.

Intergrinding may be performed utilizing any suitable grinding means, as will be apparent in light of this disclosure. For example, in accordance with some embodiments, intergrinding may be performed, in part or in whole, utilizing a mill with a grinding aid and media. The specific type of mill may be customized, as desired for a given target application or end-use. In some cases, the mill may be, for instance, a rotary mill, such as a ball mill. In accordance with some embodiments, intergrinding may be performed (in part or in whole) utilizing a mill configured as disclosed in U.S. Pat. No. 9,254,490 (“Process for Treating Fly Ash and a Rotary Mill Therefor”), the entire disclosure of which is herein incorporated by reference. In accordance with some embodiments, intergrinding may involve a grinding aid and media configured as disclosed in U.S. Pat. No. 9,254,490.

The duration of the intergrinding of the materials related to method 1000 may be customized, as desired for a given target application or end-use. For example, in accordance with some embodiments, intergrinding may be performed for about 1-15 minutes. In accordance with some embodiments, intergrinding may be performed for about 3-8 minutes. As will be appreciated in light of this disclosure, the intergrinding of materials may be performed, for example, until a given target particle size distribution is achieved, at least in some instances. For example, in some instances, intergrinding may occur until a D90 particle size distribution in the range of about 20-40 μm (e.g., about 20-25 μm, about 25-30 μm, about 30-35 μm, about 35-40 μm, or any other sub-range in the range of about 20-40 μm) is achieved. In some cases, intergrinding may occur until a D90 particle size distribution of about 38 μm (+3 μm) is achieved. In some cases, intergrinding may occur until a D90 particle size distribution of about 28 μm (+3 μm) is achieved. Other suitable durations and target particle size distributions for the materials associated with method 1000 will be apparent in light of this disclosure.

In accordance with some embodiments, method 1000 optionally may include, as in block 1003, adding at least one of (1) expanded perlite waste (produced while expanding raw perlite ore to make “popped” perlite) and (2) expanded perlite. In accordance with some embodiments, both expanded perlite waste and expanded perlite may be combined with raw perlite ore. In accordance with some embodiments, the expanded perlite may be (or otherwise may include) HARBORLITE® thermally expanded perlite available from Imerys USA, Inc. Other suitable types of expanded perlite will be apparent in light of this disclosure.

The amounts of expanded perlite waste and/or expanded perlite may be customized, as desired for a given target application or end-use. In accordance with some embodiments, the expanded perlite waste may constitute about 6 wt % or less (e.g., about 1-2 wt %, about 2-3 wt %, about 3-4 wt %, about 4-5 wt %, about 5-6 wt %, or any other sub-range in the range of about 6 wt % or less) of a given mixture produced according to method 1000. In accordance with some embodiments, the expanded perlite may constitute about 1 wt % or less (e.g., about 0.25-0.5 wt %, about 0.5-0.75 wt %, about 0.75-1 wt %, or any other sub-range in the range of about 1 wt % or less) of a given mixture produced according to method 1000. Other suitable quantities of expanded perlite waste and expanded perlite will be apparent in light of this disclosure.

In some cases, the expanded perlite waste and/or expanded perlite may be ground down in a mill (e.g., such as any of the mills noted herein) with PVA powder and one or more polycarboxylate materials and then mixed with ground-down perlite ore by intergrinding (e.g., for 1-5 minutes) in such mill. These additive(s) may be prepared as a separate product which may be added to facilitate reactions as described herein, in accordance with some embodiments. In accordance with some embodiments, the expanded perlite waste may be treated with a quantity of PVA powder in the range of about 0.2 wt % or less (e.g., about 0.05-0.1 wt %, about 0.1-0.15 wt %, about 0.15-0.2 wt %, or any other sub-range in the range of about 0.2 wt % or less). In some cases, the quantity of PVA powder may be about 0.15 wt %±0.05 wt %. Other suitable quantities of PVA powder for treatment of the expanded perlite waste will be apparent in light of this disclosure.

### Concrete

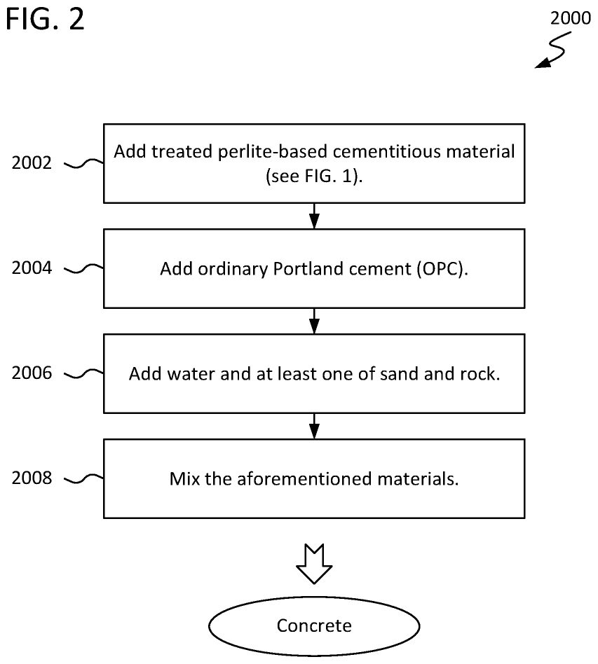

FIG. 2 illustrates a method 2000 of making concrete in accordance with an embodiment of the present disclosure. As can be seen, method 2000 may include, as in block 2002, adding the treated perlite-based cementitious material produced via method 1000 (see FIG. 1). The amount of such cementitious material added may be customized, as desired for a given target application or end-use. In accordance with some embodiments, the cementitious material may constitute about 25-50 wt % (e.g., about 25-30 wt %, about 30-35 wt %, about 35-40 wt %, about 40-45 wt %, about 45-50 wt %, or any other sub-range in the range of about 25-50 wt %) of a given concrete produced according to method 2000. Other suitable quantities of cementitious material will be apparent in light of this disclosure.

Method 2000 may include, as in block 2004, adding OPC. The amount of OPC added may be customized, as desired for a given target application or end-use. In accordance with some embodiments, the OPC may constitute about 25-50 wt % (e.g., about 25-30 wt %, about 30-35 wt %, about 35-40 wt %, about 40-45 wt %, about 45-50 wt %, or any other sub-range in the range of about 25-50 wt %) of a given concrete produced according to method 2000. In accordance with some embodiments, the OPC and the treated perlite-based cementitious material may be provided in a 50-50 powder blend ratio. Other suitable quantities of OPC will be apparent in light of this disclosure.

Method 2000 may include, as in block 2006, adding water and at least one of sand and rock. In accordance with some embodiments, the sand may include, for example, screened sand meeting ASTM C989 standards. In accordance with some embodiments, the rock material may include, for example, ¾″ limestone rock meeting ASTM C33 standards. The amounts of sand and/or rock added may be customized, as desired for a given target application or end-use. In accordance with some embodiments, the sand may constitute about 45-55 wt % (e.g., about 45-50 wt %, about 50-55 wt %, or any other sub-range in the range of about 45-55 wt %) of a given concrete produced according to method 2000. In accordance with some embodiments, the rock may constitute about 45-55 wt % (e.g., about 45-50 wt %, about 50-55 wt %, or any other sub-range in the range of about 45-55 wt %) of a given concrete produced according to method 2000. Other suitable types and quantities of sand and rock will be apparent in light of this disclosure.

The water-cement (w/c) ratio for concrete produced according to method 2000 also may be customized, as desired for a given target application or end-use. In some cases, the w/c ratio may be in the range of about 0.2-0.4 (e.g., about 0.2-0.25, about 0.25-0.3, about 0.3-0.35, about 0.35-0.4, or any other sub-range in the range of about 0.25-0.4). In some cases, the w/c ratio may be in the range of about 0.25-0.38 (e.g., about 0.25-0.31, about 0.31-0.38, or any other sub-range in the range of about 0.25-0.38). In some cases, the w/c ratio may be in the range of about 0.2-0.33 (e.g., about 0.2-0.26, about 0.26-0.33, or any other sub-range in the range of about 0.2-0.33). In some cases, the w/c ratio may be in the range of about 0.23-0.3 or 0.23-0.4. Other suitable w/c ratios for materials associated with method 2000 will be apparent in light of this disclosure.

Method 2000 may include, as in block 2008, mixing the (1) treated perlite-based cementitious material, (2) OPC, (3) water, and (4) at least one of sand and rock. The noted materials may be mixed with one another (e.g., all at once or in one or more intermediate combinations) to provide a concrete including a treated perlite-based cementitious material, in accordance with some embodiments. Mixing may be performed as typically done with concrete products. Moreover, the duration of the mixing of the materials related to method 2000 may be customized, as desired for a given target application or end-use. As will be appreciated in light of this disclosure, it may be desirable to ensure that mixing is curtailed with sufficient time to provide for pouring, forming, etc., the concrete as desired.

### Example Concrete Batch #1

In accordance with an example embodiment, a first example concrete batch including the following constituent materials was made: (1) treated perlite-based cementitious material; (2) Type 1-2 OPC having typical fineness distribution; (3) screened sand meeting ASTM C989 standards; and (4) water. The treated perlite-based cementitious material was used at about 50 wt % replacement of OPC.

The aforementioned treated perlite-based cementitious material was mixed as follows: (1) raw perlite ore; (2) 0.15 wt % PVA powder; (3) 0.3 wt % WEGO Polycarboxylate-PCX; and (4) 0.05 wt % triethanolamine (TEA) grinding aid. The perlite-based cementitious material had a D90 PSD of 38 μm.

Table 1 below tabulates measured compressive strengths for several cubes of concrete cured at an ambient temperature in the range of about 73 ºF (+3 ºF) in conditions meeting ASTM C989 standards. The compressive strengths were obtained by breaking the cubes.

TABLE 1

| | | Compressive Strength (PSI) | | | |
|---|---|---|---|---|---|
| Water (mL) | Flow (mm) | 1 Day | 7 Days | 28 Days | 56 Days |
| 195 | 108 | 2,080 | 4,420 | 6,770 | 6,990 |

### Example Concrete Batch #2

In accordance with an example embodiment, a second example concrete batch including the following constituent materials was made: (1) treated perlite-based cementitious material; (2) Type 1-2 OPC having typical fineness distribution; (3) screened sand meeting ASTM C989 standards; and (4) water. The treated perlite-based cementitious material was used at about 50 wt % replacement of OPC.

The aforementioned treated perlite-based cementitious material was mixed as follows: (1) raw perlite ore; (2) 0.15 wt % PVA powder; (3) 0.3 wt % WEGO Polycarboxylate-PCX; and (4) 0.05 wt % triethanolamine (TEA) grinding aid. The perlite-based cementitious material had a D90 PSD of 28 μm.

Table 2 below tabulates measured compressive strengths for several cubes of concrete cured at an ambient temperature in the range of about 73 ºF (+3 ºF) in conditions meeting ASTM C989 standards. The compressive strengths were obtained by breaking the cubes.

TABLE 2

| | | Compressive Strength (PSI) | | | |
|---|---|---|---|---|---|
| Water (mL) | Flow (mm) | 1 Day | 7 Days | 28 Days | 56 Days |
| 195 | 106 | 2,020 | 4,220 | 6,670 | 7,090 |

### Example Concrete Batch #3

In accordance with an example embodiment, a third example concrete batch including the following constituent materials was made: (1) treated perlite-based cementitious material; (2) Type 1-2 OPC having typical fineness distribution; (3) screened sand meeting ASTM C989 standards; and (4) water. The treated perlite-based cementitious material was used at about 50 wt % replacement of OPC.

The aforementioned treated perlite-based cementitious material was mixed as follows: (1) raw perlite ore; (2) 5 wt % class C fly ash; (3) 0.15 wt % PVA powder; (4) 0.3 wt % WEGO Polycarboxylate-PCX; and (5) 0.05 wt % triethanolamine (TEA) grinding aid. The perlite-based cementitious material had a D90 PSD of 28 μm.

Table 3 below tabulates measured compressive strengths for several cubes of concrete cured at an ambient temperature in the range of about 73 ºF (+3° F.) in conditions meeting ASTM C989 standards. The compressive strengths were obtained by breaking the cubes.

TABLE 3

| | | Compressive Strength (PSI) | | | |
|---|---|---|---|---|---|
| Water (mL) | Flow (mm) | 1 Day | 7 Days | 28 Days | 56 Days |
| 195 | 116 | 2,030 | 4,180 | 6,840 | 6,750 |

### Example Concrete Batch #4

In accordance with an example embodiment, a fourth example 5.02-sak concrete batch including the following constituent materials was made: (1) treated perlite-based cementitious material; (2) Type 1-2 OPC having typical fineness distribution; (3) ¾″ limestone rock meeting ASTM C33 standards; (4) screened sand meeting ASTM C989 standards; and (5) water. The treated perlite-based cementitious material was used at about 50 wt % replacement of OPC. The water-cement (w/c) ratio of this batch was 0.45.

The aforementioned treated perlite-based cementitious material was mixed as follows: (1) about 94.2 wt % raw perlite ore having a D90 PSD of about 36 μm; (2) about 5 wt % expanded perlite fine wastes (generated from the expansion process on perlite ore) having a D90 PSD of about 40 μm; (3) about 0.5 wt % expanded perlite having a D90 PSD of about 25 μm; (4) about 0.05 wt % PVA powder; (5) about 0.2 wt % WEGO Polycarboxylate-PCX; and (6) about 0.05 wt % TEA grinding aid.

Table 4 below tabulates measured compressive strengths for several cylinders of concrete cured at an ambient temperature in the range of about 90 ºF (+3 ºF) in conditions meeting ASTM C 989 standards. The compressive strengths were obtained by breaking the cylinders.

TABLE 4
Compressive Strength (PSI)

| Sample | 1 Day | 3 Days | 7 Days | 14 Days | 28 Days |
|---|---|---|---|---|---|
| #1 | 1,180 | 2,155 | 2,561 | 3,153 | 3,734 |
| #2 | 1,227 | — | 2,438 | — | 3,678 |
| AVG. | 1,204 | 2,155 | 2,500 | 3,153 | 3,706 |

### Example Concrete Batch #5

In accordance with an example embodiment, a fifth example 5.02-sak concrete batch including the following constituent materials was made: (1) treated perlite-based cementitious material; (2) Type 1-2 OPC having typical fineness distribution; (3) ¾″ limestone rock meeting ASTM C33 standards; (4) screened sand meeting ASTM C989 standards; and (5) water. The treated perlite-based cementitious material was used at about 50 wt % replacement of OPC. The water-cement (w/c) ratio of this batch was 0.63.

The aforementioned treated perlite-based cementitious material was mixed as follows: (1) about 94.2 wt % raw perlite ore having a D90 PSD of about 36 μm; (2) about 5 wt % expanded perlite fine wastes (generated from the expansion process on perlite ore) having a D90 PSD of about 40 μm; (3) about 0.5 wt % expanded perlite having a D90 PSD of about 25 μm; (4) about 0.05 wt % PVA powder; (5) about 0.2 wt % WEGO Polycarboxylate-PCX; and (6) about 0.05 wt % TEA grinding aid.

Table 5 below tabulates measured compressive strengths for several cylinders of concrete cured at an ambient temperature in the range of about 90 ºF (+3 ºF) in conditions meeting ASTM C 989 standards. The compressive strengths were obtained by breaking the cylinders.

TABLE 5
Compressive Strength (PSI)

| Sample | 1 Day | 3 Days | 7 Days | 14 Days | 28 Days |
|---|---|---|---|---|---|
| #1 | 670 | — | 1,597 | 2,173 | 2,875 |
| #2 | 699 | — | 1,669 | — | 2,910 |
| AVG. | 685 | 2,155 | 1,633 | 2,173 | 2,893 |

### Example Concrete Batch #6

In accordance with an example embodiment, a sixth example concrete batch including the following constituent materials was made: (1) treated perlite-based cementitious material; (2) Type 1-2 OPC having typical fineness distribution; (3) screened sand meeting ASTM C989 standards; and (4) water. The treated perlite-based cementitious material was used at about 50 wt % replacement of OPC.

The aforementioned treated perlite-based cementitious material was mixed as follows: (1) about 93.5 wt % raw perlite ore (e.g., available from Imerys USA, Inc.; sourced from Colorado) having a D90 PSD of about 38 μm; (2) about 6 wt % expanded perlite waste (e.g., available from Imerys USA, Inc.; sourced from Texas) having a D90 PSD of about 20 μm; and (3) about 0.5 wt % expanded perlite (e.g., Imerys HARBORLITE® thermally expanded perlite) having a D90 PSD of about 20 μm. The expanded perlite waste and the expanded perlite each were treated with about 0.15 wt % PVA powder, about 0.3 wt % WEGO Polycarboxylate-PCX, and about 0.05 wt % TEA grinding aid. These materials were mixed together proportionally in a single mill and ground to a D90 PSD of about 38 μm/kg (e.g., about 20 min) in the presence of about 0.15 wt % PVA powder, about 0.3 wt % WEGO Polycarboxylate-PCX, and about 0.05 wt % TEA grinding aid.

Table 6 below tabulates measured compressive strengths for several cubes of concrete cured in conditions meeting ASTM C989 standards. The compressive strengths were obtained by breaking the cubes.

TABLE 6

| | | Compressive Strength (PSI) | | | | |
|---|---|---|---|---|---|---|
| Water (mL) | Flow (mm) | 1 Day | 3 Days | 7 Days | 14 Days | 28 Days |
| 180 | 105 | 2,110 | 3,550 | 4,360 | 4,680 | 6,920 |

### Example Concrete Batch #7

In accordance with an example embodiment, a seventh example concrete batch including the following constituent materials was made: (1) treated perlite-based cementitious material; (2) Type 1-2 OPC having typical fineness distribution; (3) screened sand meeting ASTM C989 standards; and (4) water. The treated perlite-based cementitious material was used at about 50 wt % replacement of OPC.

The aforementioned treated perlite-based cementitious material was mixed as follows: (1) about 93.5 wt % raw perlite ore (e.g., Dicalite DICAPERL® perlite; sourced from New Mexico) having a D90 PSD of about 38 μm; (2) about 6 wt % expanded perlite waste (e.g., available from Dicalite Management Group; sourced from Maine) having a D90 PSD of about 20 μm; and (3) about 0.5 wt % expanded perlite (e.g., Imerys HARBORLITE® thermally expanded perlite) having a D90 PSD of about 20 μm. The expanded perlite waste and the expanded perlite each were treated with about 0.15 wt % PVA powder, about 0.3 wt % WEGO Polycarboxylate-PCX, and about 0.05 wt % TEA grinding aid. These materials were mixed together proportionally in a single mill and ground to a D90 PSD of about 38 μm/kg (e.g., about 35 min) in the presence of about 0.15 wt % PVA powder, about 0.3 wt % WEGO Polycarboxylate-PCX, and about 0.05 wt % TEA grinding aid.

Table 7 below tabulates measured compressive strengths for several cubes of concrete cured in conditions meeting ASTM C989 standards. The compressive strengths were obtained by breaking the cubes.

TABLE 7

| | | Compressive Strength (PSI) | | | | |
|---|---|---|---|---|---|---|
| Water (mL) | Flow (mm) | 1 Day | 3 Days | 7 Days | 14 Days | 28 Days |
| 180 | 107 | 2,280 | 3,800 | 4,590 | 5,630 | 7,270 |

### Analysis & Conclusions

The data of Tables 1-7 above generally indicate that raw perlite ore may be made reactive without grinding down to a very fine particle size (e.g., a D90 of about 28-38 μm may be sufficient). The data also generally indicate the difference in treating the higher surface area particles (smaller size) makes on the results. Additionally, the data generally indicate that coating the surface of the perlite with PVA powder may help to improve the cementitious reaction of the perlite ore, while the polycarboxylate may help to control the water demand, thus permitting good flowability. The data also indicate that these reactions may occur in concrete batches using the same treatment and varying the w/c ratio to obtain good flowability. The data also generally indicate that the mix may hit typical 28-day strengths at or above where an OPC mix alone would, albeit at a lower w/c ratio. Furthermore, the data generally indicate that the use of PVA powder and polycarboxylate material, in combination with mill-based processing, may yield a viable, high-replacement alternative to other pozzolans (e.g., fly ash, slag, etc.) in making cementitious materials and concrete. Also, the data indicate that, at least in some cases, the lightweight nature of the expanded perlite wastes, when processed as described herein, increased from about 7 lbs./ft³ to about 12 lbs./ft³ but its reactivity was higher than just the raw perlite ore itself.

Furthermore, testing of the alkali content of the perlite, as variously described herein, showed a total alkali value ranging from about 6-8%. Alkali-silica reactivity (ASR) tests indicated that less than about 1% (e.g., about 0.5-0.9% or less) of the alkali in the glass matrix was “available.” Therefore, no problems were seen on material ground down to the disclosed D90 particle sizes when tested on available alkali, as the class C fly ash had more available alkali than the perlite. In at least some cases, inclusion of an additive package (e.g., lithium carbonate/hydroxide interground with perlite ore/glass at about 0.15-0.3 wt %) may prevent (or otherwise reduce) ASR-related problems, in accordance with some embodiments.

The foregoing description of example embodiments has been presented for the purposes of illustration and description. It is not intended to be exhaustive or to limit the present disclosure to the precise forms disclosed. Many modifications and variations are possible in light of this disclosure. It is intended that the scope of the present disclosure be limited not by this detailed description. Future-filed applications claiming priority to this application may claim the disclosed subject matter in a different manner and generally may include any set of one or more limitations as variously disclosed or otherwise demonstrated herein.

1. A method comprising:
producing a treated perlite-based cementitious mixture comprising:
raw perlite ore;
polyvinyl alcohol (PVA) powder; and
a polycarboxylate material.

2-3. (canceled)

4. The method of claim 1, wherein producing the treated perlite-based cementitious mixture involves intergrinding the raw perlite ore, the PVA powder, and the polycarboxylate material until a D90 particle size distribution of about 38 μm is achieved for the treated perlite-based cementitious mixture.

5. The method of claim 1, wherein producing the treated perlite-based cementitious mixture involves intergrinding the raw perlite ore, the PVA powder, and the polycarboxylate material until a D90 particle size distribution of about 28 μm is achieved for the treated perlite-based cementitious mixture.

6. The method of claim 1, wherein the treated perlite-based cementitious mixture further comprises at least one of calcium sulfate (CaSO₄) and calcium sulfite (CaSO₃).

7. The method of claim 6, wherein producing the treated perlite-based cementitious mixture involves intergrinding the raw perlite ore, the PVA powder, the polycarboxylate material, and the at least one of calcium sulfate and calcium sulfite.

8. The method of claim 1, wherein the treated perlite-based cementitious mixture further comprises at least one of expanded perlite waste and expanded perlite.

9. The method of claim 8, wherein producing the treated perlite-based cementitious mixture involves intergrinding the raw perlite ore, the PVA powder, the polycarboxylate material, and the at least one of expanded perlite waste and expanded perlite.

10. The method of claim 1, wherein the treated perlite-based cementitious mixture further comprises expanded perlite waste and expanded perlite.

11. The method of claim 10, wherein producing the treated perlite-based cementitious mixture involves intergrinding the raw perlite ore, the PVA powder, the polycarboxylate material, the expanded perlite waste, and the expanded perlite.

12. A method comprising:
producing a concrete comprising:
the treated perlite-based cementitious mixture produced according to claim 1;
ordinary Portland cement (OPC);
water; and
at least one of rock and sand.

13. The method of claim 12, wherein the treated perlite-based cementitious mixture and the OPC are provided in a 50-50 blend.

14. A concrete product comprising concrete produced according to claim 12.

15. A composition of matter comprising:
raw perlite ore;
polyvinyl alcohol (PVA) powder; and
a polycarboxylate material.

16. (canceled)

17. The composition of matter of claim 15, wherein the composition of matter has a D90 particle size distribution of about 38 μm±3 μm.

18. The composition of matter of claim 15, wherein the composition of matter has a D90 particle size distribution of about 28 μm±3 μm.

19-21. (canceled)

22. The composition of matter of claim 15, further comprising ordinary Portland cement (OPC).

23. The method of claim 1, wherein the treated perlite-based cementitious mixture further comprises expanded perlite waste, wherein the expanded perlite waste constitutes about 6 wt % or less of the treated perlite-based cementitious mixture.

24-28. (canceled)

29. The method of claim 1, wherein the treated perlite-based cementitious mixture further comprises expanded perlite, wherein the expanded perlite constitutes about 1 wt % or less of the treated perlite-based cementitious mixture.

30-32. (canceled)

33. The method of claim 1, wherein the treated perlite-based cementitious mixture further comprises:
expanded perlite waste, wherein the expanded perlite waste constitutes about 5 wt % of the treated perlite-based cementitious mixture; and
expanded perlite, wherein the expanded perlite constitutes about 0.5 wt % of the treated perlite-based cementitious mixture.

34. The method of claim 33, wherein at least one of:
the expanded perlite waste has a D90 particle size distribution of about 40 μm;
the expanded perlite has a D90 particle size distribution of about 25 μm;
the PVA powder constitutes about 0.05 wt % of the treated perlite-based cementitious mixture; and
the polycarboxylate material constitutes about 0.2 wt % of the treated perlite-based cementitious mixture.

35-37. (canceled)

38. The method of claim 1, wherein the treated perlite-based cementitious mixture further comprises:
expanded perlite waste, wherein the expanded perlite waste constitutes about 6 wt % of the treated perlite-based cementitious mixture; and
expanded perlite, wherein the expanded perlite constitutes about 0.5 wt % of the treated perlite-based cementitious mixture.

39. The method of claim 38, wherein at least one of:
the expanded perlite waste has a D90 particle size distribution of about 20 μm
the expanded perlite has a D90 particle size distribution of about 20 μm;
the PVA powder constitutes about 0.15 wt % of the treated perlite-based cementitious mixture; and
the polycarboxylate material constitutes about 0.3 wt % of the treated perlite-based cementitious mixture.

40-42. (canceled)

43. The method of claim 1, wherein the treated perlite-based cementitious mixture further comprises calcium sulfite (CaSO₃), wherein the calcium sulfite constitutes 1.5-3 wt % of the treated perlite-based cementitious mixture.

44-46. (canceled)

47. The method of claim 1, wherein the treated perlite-based cementitious mixture further comprises calcium sulfate (CaSO₄), wherein the calcium sulfate constitutes 0.1-1.5 wt % of the treated perlite-based cementitious mixture.

48-50. (canceled)

51. The composition of matter of claim 15, further comprising expanded perlite waste, wherein the expanded perlite waste constitutes about 6 wt % or less of the composition of matter.

52-56. (canceled)

57. The composition of matter of claim 15, further comprising expanded perlite, wherein the expanded perlite constitutes about 1 wt % or less of the composition of matter.

58-60. (canceled)

61. The composition of matter of claim 15, further comprising:
expanded perlite waste, wherein the expanded perlite waste constitutes about 5 wt % of the composition of matter; and
expanded perlite, wherein the expanded perlite constitutes about 0.5 wt % of the composition of matter.

62. The composition of matter of claim 61, wherein at least one of:
the expanded perlite waste has a D90 particle size distribution of about 40 μm;
the expanded perlite has a D90 particle size distribution of about 25 μm;
the PVA powder constitutes about 0.05 wt % of the composition of matter; and
the polycarboxylate material constitutes about 0.2 wt % of the composition of matter.

63-65. (canceled)

66. The composition of matter of claim 15, further comprising:
expanded perlite waste, wherein the expanded perlite waste constitutes about 6 wt % of the composition of matter; and
expanded perlite, wherein the expanded perlite constitutes about 0.5 wt % of the composition of matter.

67. The composition of matter of claim 66, wherein at least one of:
the expanded perlite waste has a D90 particle size distribution of about 20 μm;
the expanded perlite has a D90 particle size distribution of about 20 μm;
the PVA powder constitutes about 0.15 wt % of the composition of matter; and
the polycarboxylate material constitutes about 0.3 wt % of the composition of matter.

68-70. (canceled)

71. The composition of matter of claim 15, further comprising calcium sulfite (CaSO₃), wherein the calcium sulfite constitutes 1.5-3 wt % of the composition of matter.

72-74. (canceled)

75. The composition of matter of claim 15, further comprising calcium sulfate (CaSO₄), wherein the calcium sulfate constitutes 0.1-1.5 wt % of the composition of matter.

76-78. (canceled)
